(19) United States
(12) Patent Application Publication
(10) Pub. No.: US 2015/0190843 A1
(43) Pub. Date: Jul. 9, 2015

(54) METHOD OF PREPARING SILICA-COATED NANODIAMONDS

(71) Applicant: The United States of America, as represented by the Secretary, Department of Health and Human Serv, Bethesda, MD (US)

(72) Inventors: AMBIKA BUMB, NEWARK, CA (US); SUSANTA KUMAR SARKAR, ROCKVILLE, MD (US); KEIR C. NEUMAN, BETHESDA, MD (US); MARTIN BRECHBIEL, ANNANDALE, VA (US)

(21) Appl. No.: 14/598,414

(22) Filed: Jan. 16, 2015

Related U.S. Application Data
(63) Continuation of application No. PCT/US2013/050779, filed on Jul. 17, 2013.
(60) Provisional application No. 61/672,996, filed on Jul. 18, 2012.

(51) Int. Cl. B05D 3/10; B05D 1/18

(52) U.S. Cl. CPC B05D 3/107; B05D 1/18; Y10S 977/773; Y10S 977/892; B82Y 40/00

(57) ABSTRACT

Silica-coated nanodiamonds and methods of preparing silica-coated nanodiamonds are disclosed. The method comprises contacting a nanodiamond entrapped in a liposome with a silica precursor and reacting the silica precursor to form a coating of silica on the nanodiamond.

### CROSS REFERENCE TO RELATED APPLICATION

This application is a continuation of PCT Application No. PCT/US2013/050779, filed on Jul. 17, 2013, which claims the benefit under 35 U.S.C. §119(e) to U.S. Provisional Application No. 61/672,996, filed Jul. 18, 2012, each of which is incorporated by reference in its entirety.

### STATEMENT OF GOVERNMENT SUPPORT

This invention was made in part with government support from the National Institutes of Health. The government has certain rights in this invention.

### BACKGROUND

Nanoparticles have potential applications in a wide variety of fields, including biomedical, optical, and electronics. A nanoparticle is a particle having one or more dimensions of the order of 100 nanometer (nm) or less for which novel properties differentiate the nanoparticle from the bulk material.

Nanotechnology in medicine is making an impact in areas such as drug delivery systems, new therapies, in vivo imaging, nanoelectronics-based sensors, and neuroelectronic interfaces. Currently, there relatively few (less than 10) types of core nanoparticles that are being modified and functionalized to be applied in these various applications. Nanodiamonds are a type of nanoparticle having unique optical and magnetic properties. However, their use has been limited thus far because of the difficulty in functionalizing or coating their inert surface. Their tendency to aggregate in aqueous solution further limits their use or functionalization for use.

Nanodiamonds coated with silicon using atomic layer deposition from gaseous monosilane (SiH₄) have been reported, by sequential reaction of SiH₄ saturated adsorption and in situ decomposition. (Lu, J., et al. 2007, Applied Surface Science, 253(7): 3485-3488.)

U.S. Pat. No. 7,648,765 discloses a method of making a reverse micelle solution of monodisperse nanodiamonds by adding an aqueous colloidal solution of nanodiamonds to a reverse micelle solution of a surfactant in an organic solvent in the presence of ammonia. The nanodiamonds in the reverse micelle solution are then silica-coated by addition of a metal alkoxide in heptane to form silica-coated nanodiamonds. The silica-coated nanodiamonds in the reverse micelle solution are then dried and powdered by adding water to the organic solvent, evaporating the organic solvent, and removing the water by freeze-drying. There nonetheless remains a need in the art for improved methods of preparing silica-coated nanodiamonds.

### SUMMARY

Disclosed herein are silica-coated nanodiamonds and a method of preparing silica-coated nanodiamonds.

In an embodiment, the method comprises contacting a nanodiamond entrapped in a liposome with a silica precursor; and reacting the silica precursor to form a coating of silica on the nanodiamond.

The silica-coated nanodiamonds comprise a nanodiamond core and a silica coating disposed at least partially on the diamond core, wherein the silica-coated nanodiamonds are substantially free of surfactant.

These and other advantages, as well as additional inventive features, will be apparent from the following Drawings, Detailed Description, Examples, and Claims.

### BRIEF DESCRIPTION OF THE DRAWINGS

FIGS. 1A and 1B show transmission electron micrographs of a sample of nanodiamonds used as the starting material (FIG. 1A) for the process disclosed herein and a micrograph (FIG. 1B) of silica-coated nanodiamonds obtained by the process.

FIG. 2A is a photograph of two vials of nanodiamonds in water, the left vial containing the uncoated nanodiamond, and the right vial containing the silica-coated nanodiamond obtained from the disclosed process.

FIG. 2B is a graph of light scattering as a function of time showing precipitation of uncoated (lower dotted line) and silica-coated diamond (upper solid line) measured by light scattering.

FIGS. 3A and 3B present graphs of hydrodynamic diameter (FIG. 3A) and zeta potential (FIG. 3B) of uncoated ND starting material (circles) and the same NDs after silica-coating (squares) determined by dynamic light scattering in aqueous solution as a function of pH.

### DETAILED DESCRIPTION

Silica-coated nanodiamonds and methods of preparing silica-coated nanodiamonds are disclosed herein. The methods result in silica-coated nanodiamonds of a monodisperse particle size that are stable in aqueous solution and have a biocompatible surface that is readily functionalized. Such monodisperse and readily modifiable nanodiamonds can be used in various nanotechnology applications, including biomedical applications such as drug delivery, cell targeting, and imaging methods. In a particularly advantageous feature, the methods do not require large quantities of organic solvent, and thus are more readily scalable to commercial production.

In one aspect, a method of preparing silica-coated nanodiamonds is disclosed. In an embodiment, the method comprises contacting a nanodiamond entrapped in a liposome with a silica precursor; and reacting the silica precursor to form a coating of silica on the nanodiamond. For example, in a specific embodiment, the method comprises contacting a plurality of nanodiamonds and a tetraalkoxysilane such as tetraethyl orthosilicate, trapping the nanodiamonds and the tetraalkoxysilane within liposomes, hydrolyzing the tetraalkoxysilane to form a silica coating on the nanodiamonds in the liposomes, and purifying the silica-coated nanodiamonds from the liposomes.

A “nanodiamond” refers to a nanodimensioned diamond particle. “Diamond” as used herein includes both natural and synthetic diamonds from a variety of synthetic processes, as well as “diamond-like carbon” (DLC) in particulate form. The diamond particles have at least one dimension of less than 1 micrometer, less than 800 nm, less than 500 nm, or less than 100 nm, for example 1 nm to about 100 nm or 1 to 500 nm. The particle can be of any shape, e.g., rectangular, spherical, cylindrical, cubic, or irregular, provided that at least one dimension is nanosized, i.e., less than 1 micrometer, less than 800 nm, less than 500 nm, or less than 100 nm.

As is known in the art, accurate determination of particle dimensions in the nanometer range can be difficult. In an embodiment, the dimension of the nanodiamonds is determined using their hydrodynamic diameter. The hydrodynamic diameter of the nanodiamond or an aggregate of nanodiamonds can be measured in a suitable solvent system, such as an aqueous solution. The hydrodynamic diameter can be measured by sedimentation, dynamic light scattering, or other methods known in the art. In an embodiment, hydrodynamic diameter is determined by differential centrifugal sedimentation. Differential centrifugal sedimentation can be performed, for example, in a disc centrifuge. In an embodiment, the hydrodynamic diameter is a Z-average diameter determined by dynamic light scattering. The Z-average diameter is the mean intensity diameter derived from a cumulants analysis of the measured correlation curve, in which a single particle size is assumed and a single exponential fit is applied to the autocorrelation function. The Z-average diameter can be determined by dynamic light scattering with the sample dispersed in, for example, deionized water. An example of a suitable instrument for determining particle size and/or the polydispersity index by dynamic light scattering is a Malvern Zetasizer Nano.

Nanodiamonds are commercially available. Alternatively, nanodiamonds can be prepared by methods known in the art. Nanodiamonds can be prepared, for example, by detonation of certain explosives in a closed container, laser ablation, high energy ball milling of diamond microcrystals, plasma-assisted chemical vapor deposition, or autoclave synthesis from supercritical fluids.

To form the silica coating, the nanodiamonds are partitioned into liposomes as described below and contacted with a silica precursor. Silica precursors are selected so as to be compatible with the liposomes, and reactive under conditions where the nanodiamonds are entrapped within the liposomes. Exemplary silica precursors include tetraalkoxysilanes of the formula Si(OR)₄ wherein each R can be the same or different and is an alkyl group having 1 to 16 carbon atoms optionally substituted with ether groups (—O—). “Alkyl” means a straight or branched chain saturated aliphatic group having the specified number of carbon atoms, specifically 1 to 12 carbon atoms, more specifically 1 to 6 carbon atoms. The tetraalkoxysilane can be a mixed alkoxide with at least two different R groups, defined as before, present in the molecule. In an embodiment, the tetraalkoxysilane is tetraethoxysilane, also known as tetraethyl orthosilicate (TEOS), or tetramethoxysilane (TMOS).

Other silica precursors can be used, for example functionalized silica precursors that provide a functional group to the silica coating. Such precursors include organosilanes of the formula R¹₁₊ₓSi(X²)₃₋ₓ wherein each R¹ is the same or different and is a substituted or unsubstituted hydrocarbon group having 1 to 32 carbon atoms, each X is the same or different and is a leaving group, and is x is 0, 1, or 2. “Hydrocarbon groups” as used herein includes branched or unbranched, cyclic or acyclic, saturated, unsaturated, or aromatic groups containing carbon and hydrogen and optionally 1 to 3 heteroatoms (S, 0, P, Si, N). The groups can optionally be substituted with up to three functional groups, for example a halide (F, Cl, Br, I), cyano, nitro, carboxylic acid, carboxylic acid salt, carboxylic acid ester, carboxylic acid anhydride, acryloyl, methacryloyl, hydroxy, thiol, epoxy, trialkoxysilyl (wherein each alkyl group is the same or different and has 1 to 6 carbon atoms), amino (—NRR′, wherein R and R′ are hydrogen or a C1 to C6 alkyl group), amidino (—C(═NH)NH₂), hydrazino (—NHNH₂), hydrazono (═N(NH₂), aldehyde (—C(═O)H), carbamoyl (—C(O)NH₂), C2 to C16 alkenyl, C2 to C16 alkynyl, C6 to C30 aryl, C7 to C30 alkylarylene, 7 to C30 arylalkylene, C1 to C30 alkoxy, or C2 to C6 heterocycle such as imidazoyl, furanyl, and the like. Leaving groups X include halides and alkoxy groups of the formula —OR as defined above.

Specific examples of functionalized silica precursors include 6-azidosulfonylhexyltriethoxysilane; bis[(3-ethoxysilyl)propyl]ethylenediamine; N-[3-triethoxysilylpropyl]-4,5-dihydroimidazole; 3-aminopropyltriethoxysilane; 3-isocyanate propyltriethoxysilane, diethoxyphosphate ethyltriethoxysilane; 5,6-epoxyhexyltriethoxysilane; bis-[3-(triethoxysilyl)propyl]amine; 3-aminopropylmethyldiethoxysilane; N-(2-aminoethyl)-3-aminopropyl-trimethoxysilane; N-(2-aminoethyl)-3-aminopropyl-methyldimethoxysilane; bis-[3-(triethoxysilyl)propyl]disulfide; bis-[3-(triethoxysilyl)propyl]tetrasulfide; 3-mercaptopropyltriethoxysilane; aminopropylmethyldiethoxysilane; chloropropyltriethoxysilane; chloropropyltrimethoxysilane; glycidoxypropyltrimethoxysilane; 3-mercaptopropyltrimethoxysilane; 3-methacryloxypropyltrimethoxysilane; methyltriacetoxysilane (MTAS); methyltrimethoxysilane (MTMS); methyl tris-(butanone oxime)silane (MOS); methyl oximinosilane (MOS); methyl tris-(methyl ethyl ketoximo)silane (MOS); vinyltriethoxysilane; vinyltrimethoxysilane; vinyl tris-(butanone oxime)silane (VOS); vinyl oximinosilane (VOS); and vinyl tris-(methyl ethyl ketoximo)silane (VOS) 3-acryloxypropyltrimethoxysilane (AcPTMS), 2-cyanoethyltriethoxysilane (CETES), 3-aminopropyltriethoxysilane (APS), 3-aldehydepropyltrimethoxysilane (APMS), 3-glycidylpropylsilane, and N-(3-triethoxysilylpropyl)-4,5-dihydroimidazole (NTPDI). Bis-silylated compounds are included (e.g., wherein x is 0, each X is OR and R¹ is substituted with a trialkoxysilyl group), for example bis(trimethoxysilylethyl)benzene (BTEB), bis(triethoxysilyl)ethylene (BTESE), 1,6-bis(trimethoxysilyl)hexane (BTMH), can be used.

Care is used in the selection of the functionalized silica precursors so as to ameliorate or minimize any adverse interactions of the functionalized silica precursors and the liposomes. Care is also used in the selection of the functionalized precursors so as to ameliorate or minimize any undesired cross-reaction of the silica-coated particles, whether covalent or otherwise (i.e., to avoid gel formation, for example). In an embodiment a combination of a tetraalkoxysilane and a functionalized silica precursor is used. The relative amounts of the tetraalkoxysilane and the functionalized silica precursor can be selected so as minimize adverse side reactions, to achieve the desired degree of functionality, or both.

A “liposome” refers to an artificially-prepared vesicle composed of a lipid bilayer. Liposomes can be multilamellar vesicles (MLVs) or unilamellar vesicles (UVs). Liposomes can be composed of a single lipid or a mixture of lipids. Properties of liposomes can vary depending on the lipid composition. The lipid content is selected to permit production of unilamellar liposomes having a hydrodynamic diameter of 10 nm to 2000 nm, specifically 10 to 1000 nm, more specifically 10 to 500 nm, yet more specifically 10 to 100 nm. In an embodiment, the lipid content is selected to permit production of unilamellar liposomes having a hydrodynamic diameter of about 10 nm to about 100 nm. Exemplary liposomes have a composition including natural phospholipids. Examples of the phospholipid include a phosphatidylcholine, a phosphatidylserine, a phosphatidylinositol, a phosphatidylglycerol, a phosphatidylethanolamine, and a phosphosphingolipid. In an embodiment, the phospholipid is a phosphatidyl choline. More specifically, the phosphatidyl choline can be 1-palmitoyl-2-oleoyl-sn-glycero-3-phosphocholine (POPC).

Methods of preparing liposomes are known in the art. General elements of a procedure for preparing liposomes include preparing the lipid for hydration, hydration of the lipid with agitation, and sizing the liposomes.

For example, lipids can be prepared by dissolving the lipid in an organic solvent. Examples of the organic solvent include chloroform, a chloroform:methanol mixture, tertiary butanol, and cyclohexane. The concentration of the lipid solution can be about 10 milligram/milliliter (mg/mL) to about 20 mg/mL, or more depending on the solubility of the lipid. Once dissolved, the solvent is removed to yield a lipid film. For small volumes of organic solvent, the solvent can be evaporated using a dry nitrogen or argon stream. For larger volumes, the solvent can be removed by, for example, rotary evaporation. The lipid film is thoroughly dried, for example under a vacuum pump, to remove residual organic solvent. Dried lipid films can be stored frozen until ready to hydrate. Hydration of the dry lipid film can be performed by adding an aqueous medium to the container of dry lipid and agitating. The temperature of the hydrating medium should be above the gel-liquid crystal transition temperature (T_{c}) of the lipid and maintained above the T_{c} during the hydration period. Hydration results in a suspension of MLVs which can be downsized by a variety of techniques, including sonication or extrusion.

Liposomes can be created by sonicating lipids in water. Low shear rates create MLVs, while high shear sonication tends to form small unilamellar liposomes (SUVs). Liposomes can also be prepared, for example, by extrusion of a lipid suspension through a syringe or a membrane, or by the Mozafari method (WO2005084641).

Methods of entrapping a molecule or particle within the interior of a liposome are known in the art. For example, particles to be entrapped within the liposome can be included in the hydrating medium added to the dried lipid film. In an embodiment, an aqueous suspension of the nanodiamond and the silica precursor, e.g., a tetraalkoxysilane, is used as the hydrating medium added to a dried lipid film. Hydration and resuspension of the lipids with agitation, for example by sonication, results in formation of large multilamellar liposomes which are broken up into small unilamellar vesicles with entrapped nanodiamond and silica precursor. Alternatively, the silica precursor can be added after entrapment of the nanodiamonds. The MLVs can be broken up into SUVs by, for example, extended sonication or extrusion through a syringe or membrane. In a highly advantageous feature, large particles or aggregates of uncoated nanodiamonds precipitate from the suspension, and can be removed, resulting in a monodisperse composition of silica-coated nanodiamonds. The average size of the silica-coated nanodiamonds can be adjusted by selecting the size of the liposomes and/or by varying the reaction conditions with the silica precursor, for example by varying the percentage of the silica precursor added. The size of the liposomes can be varied by selection of the lipid composition, lipid concentration, temperature, and sonication time and power.

Hydrolysis of the silica precursor such as a tetraalkoxysilane results in silica formation on or adjacent to a surface of the nanodiamonds. The silica is the form of a layer, and can be continuous or discontinuous, i.e., may fully or partially surround the nanodiamond core, and may or may not be covalently or ionically attached to the nanodiamond core. For convenience, the silica layer thus formed is referred to herein as a “coating.” In an embodiment, the coating is continuous and fully surrounds the nanodiamond to provide a core-shell structure having a nanodiamond core and a silica shell. Methods for the hydrolysis of the silica precursors will depend on the particular precursor selected. For example, tetraalkoxysilanes hydrolyze upon exposure to water, which can be accelerated in the presence of a catalyst, as well as proceed to greater completion. Hydrolysis can be catalyzed by acid or base. Examples of catalysts include organic and inorganic acids and bases such as HF, HCl, HNO, H₂SO₄, acetic acid, ammonia, NH₄OH, KOH, various amines such as triethylamine, and KF. In an embodiment, triethylamine is added to the hydrating medium to catalyze hydrolysis of the tetraalkoxysilane to silica. The catalyst, if added to the hydrating medium, can be added before or after hydration and resuspension of the lipids. In an embodiment, the catalyst is added to the medium after resuspension of the lipids. Silica precursors such as a tetraalkoxysilane and catalyst not trapped within the SUVs can be removed from the SUV solution by, for example, dialysis of the SUVs against multiple changes of an aqueous solvent.

Purifying the silica-coated nanodiamonds from the liposomes can be performed in a variety of ways. In an embodiment, unreacted reaction components are washed away from the liposomes with the entrapped silica-coated nanodiamonds, then the liposomes are broken up by means known in the art, for example addition of a liposome-disrupting compound, such as acetic acid or a surfactant. A “liposome-disrupting compound” is a compound that, when added to an aqueous suspension of liposomes, results in disruption of the liposomes into the component lipids.

The surfactant can be an anionic, cationic, non-ionic, or zwitterionic surfactant. Exemplary surfactants include chenodeoxycholic acid; chenodeoxycholic acid sodium salt; cholic acid; dehydrocholic acid; deoxycholic acid; deoxycholic acid methyl ester; digitonin; digitoxigenin; N,N-dimethyldodecylamine oxide; docusate sodium salt; glycochenodeoxycholic acid sodium salt; glycocholic acid hydrate; glycocholic acid sodium salt hydrate; glycodeoxycholic acid monohydrate; glycodeoxycholic acid sodium salt; glycolithocholic acid 3-sulfate disodium salt; glycolithocholic acid ethyl ester; N-lauroylsarcosine sodium salt; N-lauroylsarcosine; lithium dodecyl sulfate; lugol solution; Niaproof 4, Type 4 (i.e., 7-ethyl-2-methyl-4-undecyl sulfate sodium salt; sodium 7-ethyl-2-methyl-4-undecyl sulfate); 1-octanesulfonic acid sodium salt; sodium 1-butanesulfonate; sodium 1-decanesulfonate; sodium 1-dodecanesulfonate; sodium 1-heptanesulfonate anhydrous; sodium 1-nonanesulfonate; sodium 1-propanesulfonate monohydrate; sodium 2-bromoethanesulfonate; sodium cholate hydrate; sodium choleate; sodium deoxycholate; sodium deoxycholate monohydrate; sodium dodecyl sulfate; sodium hexanesulfonate anhydrous; sodium octyl sulfate; sodium pentanesulfonate anhydrous; sodium taurocholate; sodium taurodeoxycholate; saurochenodeoxycholic acid sodium salt; taurodeoxycholic acid sodium salt monohydrate; taurohyodeoxycholic acid sodium salt hydrate; taurolithocholic acid 3-sulfate disodium salt; tauroursodeoxycholic acid sodium salt; Trizma® dodecyl sulfate (i.e., tris(hydroxymethyl)aminomethane lauryl sulfate); ursodeoxycholic acid, alkyltrimethylammonium bromide; benzalkonium chloride; benzyldimethylhexadecylammonium chloride; benzyldimethyltetradecylammonium chloride; benzyldodecyldimethylammonium bromide; benzyltrimethylammonium tetrachloroiodate; cetyltrimethylammonium bromide; dimethyldioctadecylammonium bromide; dodecylethyldimethylammonium bromide; dodecyltrimethylammonium bromide; ethylhexadecyldimethylammonium bromide; Girard's reagent T; hexadecyltrimethylammonium bromide; N,N′,N′-polyoxyethylene(10)-N-tallow-1,3-diaminopropane; thonzonium bromide; trimethyl(tetradecyl)ammonium bromide, BigCHAP (i.e., N,N-bis[3-(D-gluconamido)propyl]cholamide); bis(polyethylene glycol bis[imidazoyl carbonyl]); polyoxyethylene alcohols, such as Brij® 30 (polyoxyethylene(4) lauryl ether), Brij®35 (polyoxyethylene(23) lauryl ether), Brij® 35P, Brij® 52 (polyoxyethylene 2 cetyl ether), Brij® 56 (polyoxyethylene 10 cetyl ether), Brij® 58 (polyoxyethylene 20 cetyl ether), Brij® 72 (polyoxyethylene 2 stearyl ether), Brij® 76 (polyoxyethylene 10 stearyl ether), Brij® 78 (polyoxyethylene 20 stearyl ether), Brij® 78P, Brij® 92 (polyoxyethylene 2 oleyl ether); Brij® 92V (polyoxyethylene 2 oleyl ether), Brij® 96V, Brij® 97 (polyoxyethylene 10 oleyl ether), Brij® 98 (polyoxyethylene(20) oleyl ether), Brij® 58P, and Brij® 700 (polyoxyethylene(100) stearyl ether); Cremophor® EL (i.e., polyoxyethylenglyceroltriricinoleat 35; polyoxyl 35 castor oil); decaethylene glycol monododecyl ether; decaethylene glycol mono hexadecyl ether; decaethylene glycol mono tridecyl ether; N-decanoyl-N-methylglucamine; n-decyl .alpha.-D-glucopyranoside; decyl .beta.-D-maltopyranoside; digitonin; n-dodecanoyl-N-methylglucamide; n-dodecyl .alpha.-D-maltoside; n-dodecyl .beta.-D-maltoside; heptaethylene glycol monodecyl ether; heptaethylene glycol monododecyl ether; heptaethylene glycol monotetradecyl ether; n-hexadecyl .beta.-D-maltoside; hexaethylene glycol monododecyl ether; hexaethylene glycol monohexadecyl ether; hexaethylene glycol monooctadecyl ether; hexaethylene glycol monotetradecyl ether; Igepal® CA-630 (i.e., nonylphenyl-polyethylenglykol, (octylphenoxy)polyethoxyethanol, octylphenyl-polyethylene glycol); methyl-6-O—(N-heptylcarbamoyl)-.alpha.-D-glucopyranoside; nonaethylene glycol monododecyl ether; N-nonanoyl-N-methylglucamine; octaethylene glycol monodecyl ether; octaethylene glycol monododecyl ether; octaethylene glycol monohexadecyl ether; octaethylene glycol monooctadecyl ether; octaethylene glycol monotetradecyl ether; octyl-.beta.-D-glucopyranoside; pentaethylene glycol monodecyl ether; pentaethylene glycol monododecyl ether; pentaethylene glycol monohexadecyl ether; pentaethylene glycol monohexyl ether; pentaethylene glycol monooctadecyl ether; pentaethylene glycol monooctyl ether; polyethylene glycol diglycidyl ether; polyethylene glycol ether W-1; polyoxyethylene 10 tridecyl ether; polyoxyethylene 100 stearate; polyoxyethylene 20 isohexadecyl ether; polyoxyethylene 20 oleyl ether; polyoxyethylene 40 stearate; polyoxyethylene 50 stearate; polyoxyethylene 8 stearate; polyoxyethylene bis(imidazolyl carbonyl); polyoxyethylene 25 propylene glycol stearate; saponin from quillaja bark; sorbitan fatty acid esters, such as Span® 20 (sorbitan monolaurate), Span® 40 (sorbitane monopalmitate), Span® 60 (sorbitane monostearate), Span® 65 (sorbitane tristearate), Span® 80 (sorbitane monooleate), and Span® 85 (sorbitane trioleate); various alkyl ethers of polyethylene glycols, such as Tergitol® Type 15-S-12, Tergitol® Type 15-S-30, Tergitol® Type 15-S-5, Tergitol® Type 15-S-7, Tergitol® Type 15-S-9, Tergitol® Type NP-10 (nonylphenol ethoxylate), Tergitol® Type NP-4, Tergitol® Type NP-40, Tergitol® Type NP-7, Tergitol® Type NP-9 (nonylphenol polyethylene glycol ether), Tergitol® MIN FOAM Ix, Tergitol® MIN FOAM 2x, Tergitol® Type TMN-10 (polyethylene glycol trimethylnonyl ether), Tergitor Type TMN-6 (polyethylene glycol trimethylnonyl ether), Triton® 770, Triton® CF-10 (benzyl-polyethylene glycol tert-octylphenyl ether), Triton® CF-21, Triton® CF-32, Triton® DF-12, Triton® DF-16, Triton® GR-5M, Triton® N-42, Triton® N-57, Triton® N-60, Triton® N-101 (i.e., polyethylene glycol nonylphenyl ether; polyoxyethylene branched nonylphenyl ether), Triton® QS-15, Triton® QS-44, Triton® RW-75 (i.e., polyethylene glycol 260 mono(hexadecyl/octadecyl) ether and 1-octadecanol), Triton® SP-135, Triton® SP-190, Triton® W-30, Triton® X-15, Triton® X-45 (i.e., polyethylene glycol 4-tert-octylphenyl ether; 4-(1,1,3,3-tetramethylbutyl)phenyl-polyethylene glycol), Triton® X-100 (t-octylphenoxypolyethoxyethanol; polyethylene glycol tert-octylphenyl ether; 4-(1,1,3,3-tetramethylbutyl)phenyl-polyethylene glycol), Triton® X-102, Triton® X-114 (polyethylene glycol tert-octylphenyl ether; (1,1,3,3-tetramethylbutyl)phenyl-polyethylene glycol), Triton® X-165, Triton® X-305, Triton® X-405 (i.e., polyoxyethylene(40) isooctylcyclohexyl ether; polyethylene glycol tert-octylphenyl ether), Triton® X-705-70, Triton® X-151, Triton® X-200, Triton® X-207, Triton® X-301, Triton® XL-80N, and Triton® XQS-20; tetradecyl-.beta.-D-maltoside; tetraethylene glycol monodecyl ether; tetraethylene glycol monododecyl ether; tetraethylene glycol monotetradecyl ether; triethylene glycol monodecyl ether; triethylene glycol monododecyl ether; triethylene glycol monohexadecyl ether; triethylene glycol monooctyl ether; triethylene glycol monotetradecyl ether; polyoxyethylene sorbitan fatty acid esters, such as TWEEN® 20 (polyethylene glycol sorbitan monolaurate), TWEEN® 20 (polyoxyethylene (20) sorbitan monolaurate), TWEEN® 21 (polyoxyethylene (4) sorbitan monolaurate), TWEEN® 40 (polyoxyethylene (20) sorbitan monopalmitate), TWEEN® 60 (polyethylene glycol sorbitan monostearate; polyoxyethylene (20) sorbitan monostearate), TWEEN® 61 (polyoxyethylene (4) sorbitan monostearate), TWEEN® 65 (polyoxyethylene (20) sorbitantristearate), TWEEN® 80 (polyethylene glycol sorbitan monooleate; polyoxyethylene (20) sorbitan monooleate), TWEEN® 81 (polyoxyethylene (5) sorbitan monooleate), and TWEEN® 85 (polyoxyethylene (20) sorbitan trioleate); tyloxapol; n-undecyl .beta.-D-glucopyranoside, CHAPS (i.e., 3-[(3-cholamidopropyl)dimethylammonio]-1-propanesulfonate); CHAPSO (i.e., 3-[(3-cholamidopropyl)dimethylammonio]-2-hydroxy-1-propanesulfonate); N-dodecylmaltoside; .alpha.-dodecyl-maltoside; .beta.-dodecyl-maltoside; 3-(decyldimethylammonio)propanesulfonate inner salt (i.e., SB3-10); 3-(dodecyldimethylammonio)propanesulfonate inner salt (i.e., SB3-12); 3-(N,N-dimethyloctadecylammonio)propanesulfonate (i.e., SB3-18); 3-(N,N-dimethyloctylammonio)propanesulfonate inner salt (i.e., SB3-8); 3-(N,N-dimethylpalmitylammonio)propanesulfonate (i.e., SB3-16); MEGA-8; MEGA-9; MEGA-10; methylheptylcarbamoyl glucopyranoside; N-nonanoyl N-methylglucamine; octyl-glucopyranoside; octyl-thioglucopyranoside; octyl-.beta.-thioglucopyranoside; 3-[N,N-dimethyl(3-myristoylaminopropyl)ammonio]propanesulfonate; deoxycholatic acid, and various combinations thereof. In some embodiments, the surfactant is sodium dodecyl sulfate (SDS) or Triton X-100.

In an embodiment, the solution of the silica-coated nanodiamonds and lipids is then dialyzed against water to obtain a solution of the silica-coated nanodiamonds in water. In an embodiment, the silica-coated nanodiamonds are isolated from the solution of the silica-coated nanodiamonds and lipids by centrifugation.

The silica-coated nanodiamonds produced are monodisperse (e.g. show a relatively narrow monomodal lognormal particle size distribution with a polydispersity index of ≦0.4, ≦0.3, or ≦0.2) and stable in aqueous solution at room temperature for extended periods of time, for example at least 24 hours, at least 48 hours, at least 7 days, or at least one month. Such stability is improved when the pH of the aqueous solution is maintained at greater than 2.5, greater than 3.0, for example 3.0 to 9.0.

Dispersity is a measure of the heterogeneity of sizes of molecules or particles in a given sample. “Monodisperse” refers to particles of the same or a similar size, while “polydisperse” refers to particles with a heterogeneous (e.g. multimodal) size distribution. The “polydispersity index” is a measure of the heterogeneity of the size distribution. For a size distribution determined by dynamic light scattering, the polydispersity index (PDI) is the width of the size distribution determined from the correlation function. Herein, an aqueous sample with a PDI ≦0.4, specifically ≦0.35, more specifically ≦0.3, and yet more specifically ≦0.2 is considered to be monodisperse.

In another particularly advantageous feature, the silica-coated nanodiamonds are substantially free of surfactant. “Substantially free of surfactant” means that the nanodiamonds contain less than 1000 parts per million based on the weight of the silica-coated nanodiamonds (“ppm”) of surfactant, less than 500 ppm of surfactant, less than 100 ppm of surfactant, less than 50 ppm of surfactant, less than 10 ppm of surfactant, less than 1 ppm of surfactant, or less than 0.5 ppm of surfactant. In an embodiment, no surfactant is detectable in the silica-coated nanodiamonds, as measured, for example, by gas chromatography-mass spectrometry (GC-MS) or high pressure liquid chromatography (HPLC).

The silica coating of the silica-coated nanodiamonds can be modified by physical or chemical treatments to alter the physical or chemical characteristics thereof. For example, the silica-coated nanodiamonds can be subjected to plasma treatment to increase the number of hydroxyl groups on the silica surface.

In other embodiments, the silica-coated nanodiamonds can be readily derivatized using methods known for derivatizing silica. Such derivatization can be used to alter the physical characteristics of the silica-coated nanodiamonds or to provide functionality for further derivatization or use. One method of covalently derivatizing a silica surface is silanization with an organofunctional trialkoxysilane or trichlorosilane as described above, for example aminoalkyltrialkoxysilanes, aminoalkyltrichlorosilanes, hydroxyalkyltrialkoxysilanes, hydroxyalkyltrichlorosilanes, carboxyalkyltrialkoxysilanes, polyethyleneglycols, epoxyalkyltrialkoxysilanes, and the like. From the specific compounds listed above, specific examples include 3-aminopropyltriethoxysilane (APTES), (3-aminopropyl)-dimethylethoxysilane (APDMES), N-(2-aminoethyl)-3-aminopropyltrimethoxysilane (AEAPS), 3-aldehydepropyltrimethoxysilane (APMS), mercaptopropyltrimethoxysilane (MPTMS), and mercaptopropyltriethoxysilane (MPTES), and others, such as aminotriethoxysilane. Other specific examples of derivatizing agents particularly suited for modifying the physical characteristics (e.g., hydrophilicity) of the silica-coated nanoparticles include 2-[methoxy(polyethyleneoxy)propyl]trimethoxysilane, 2-[methoxy(polyethyleneoxy-propylenoxy)propyl]trimethoxysilane, (C1-32alkyl)trichlorosilanes such as octadecyltrichlorosilane.

Where derivatization agent includes a functional group, the functional group can be further derivatized. Thus, it is also possible to use a functionalized trialkoxysilane or trichlorosilane as a linking group between the silica surface and another molecule, such as a monomer or hydrophilic polymer (e.g., methyl cellulose, poly(vinyl alcohol), dextran, starch, or glucose). The functional group of the trialkoxysilane or trichlorosilane is selected to react with the other molecule, and can be any of those described above, for example, a vinyl, allyl, epoxy, acryloyl, methacryloyl, sulfhydryl, amino, hydroxy, or the like. The functionalization can be simultaneous or stepwise.

Noncovalent functionalization of silica surfaces can be based on electrostatic interactions due to the negative nature of silica above about pH 3.5. For example, positively charged polymers can adsorb electrostatically to the silica surface.

In a specific embodiment the silica-coated nanodiamonds are chemically or physically functionalized to include a labeling material, a therapeutic agent, and/or targeting agent. The functionalization can be direct, or via a linker as described above.

The term “labeling material” refers to a material which is detectable by a physical or chemical method to permit identification of the location or quantity of the silica-coated nanodiamond. Detectable materials include fluorescent materials, dyes, light-emitting materials, radioactive materials, enzymes, and prosthetic groups. Examples of fluorescent materials include umbelliferone, fluorescein, fluorescein isothiocyanate, rhodamine, dichlorotriazinylamine fluorescein, dansyl chloride or phycoerythrin. Examples of light-emitting materials include luminol, and examples of radioactive materials include 125I, 131I, 35S, and 3H. Examples of enzymes include horseradish peroxidase, alkaline phosphatase, β-galactosidase or acetylcholinesterase. Examples of prosthetic groups include streptavidin/biotin and avidin/biotin. Detection of the labeling material can be performed by a method known in the art.

The therapeutic agent can be any known in the art. In an embodiment, the therapeutic agent is an anti-inflammatory agent, an antidiabetic agent, a chemotherapeutic agent, or an anti-angiogenesis agent.

The targeting agent can be a molecule that directs the nanodiamond to a specific cell type. For example, the targeting agent can be a ligand that specifically binds with a receptor found on the surface of a particular cell type of interest or a molecule that is selectively transferred within a particular cell type of interest.

Other embodiments of the present invention are described in the following non-limiting Examples.

### EXAMPLES

### Example 1

### Preparing Silica-Coated Nanodiamonds

The phospholipid 16:0-18:1 1-palmitoyl-2-oleoyl-sn-glycero-3-phosphocholine (POPC) is known to form liposomes with a diameter of 100 nm. POPC (10 mg; Avanti Polar Lipids, Inc.) dissolved in chloroform (25 mg/mL) in a glass vial was dehydrated at room temperature under a nitrogen stream to form thin layers on the walls of the glass vial, and then further dried under vacuum desiccation for 45 min.

A quantity (1.25 gram (g)) of −30 nm nanodiamonds (ND; Microdiamant AG) was dissolved into 11 mL deionized (DI) water and sonicated in a water bath at room temperature for 30 minutes (min) To 2.5 mL of the ND solution, 2.5 mL 1% (v/v) tetraethylorthosilicate (TEOS) in ethanol was added. The ND/TEOS solution was then immediately transferred to the glass vial with the POPC thin layers. The phospholipid was re-suspended by sonicating the glass vial in a room temperature water bath sonicator for ten min. The TEOS alkoxy silane undergoes hydrolysis and condensation to form silica along with ethanol and water. A volume of 7.5 microliter (μL) of triethylamine (TEA) was added to the reaction to catalyze silinization. The solution was then ultrasonicated for 40 min to break the multilamellar phospholipid vesicles (MLV) into small unilamellar vesicles (SUV) of the desired liposome diameter with entrapped ND and TEOS. These SUVs, thus, became mini-factories to coat entrapped ND with silica. After ultrasonication, TEOS and TEA not trapped within the SUVs were washed away by dialysis with multiple changes of water over a period of 48 hours (hrs).

To dissolve the liposomes and isolate the silica-coated ND, 500 μL of 10%(w/v) sodium dodecyl sulfate (SDS) was added to the solution and sonicated in a water bath at room temperature for 2 hrs. Then, dialysis against water was again repeated to remove POPC and SDS from the solution of silica-coated ND. The final solution of silica-coated ND was stored at room temperature.

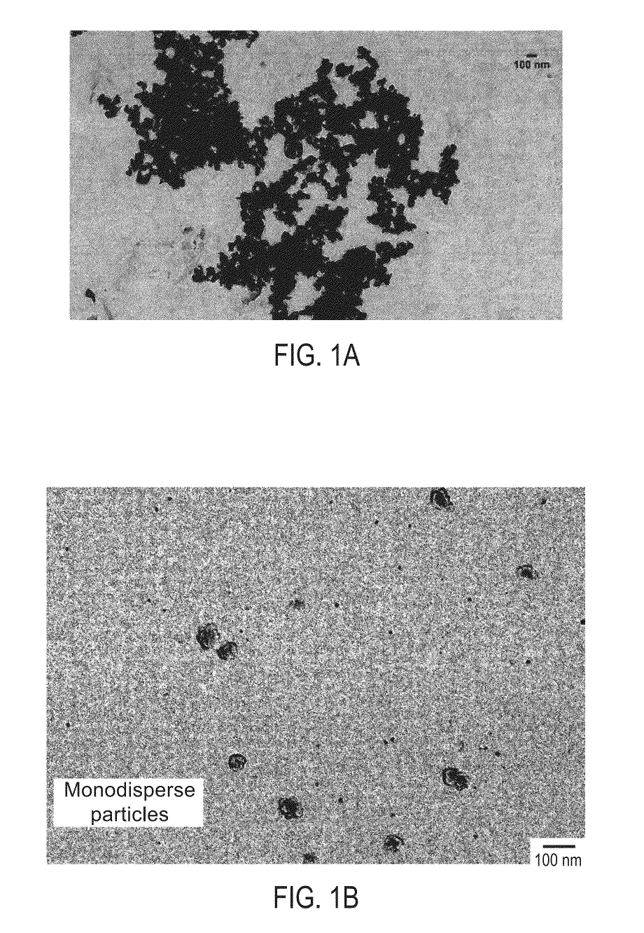

The silica-coated NDs showed different properties than the uncoated starting NDs. FIGS. 1A and 1B show two transmission electron micrographs, each with a bar denoting 100 nm. FIG. 1A is a micrograph of the initial starting nanodiamonds, while FIG. 1B is a micrograph of the resultant silica-coated nanodiamonds. The uncoated nanodiamonds aggregate into large structures, while the silica-coated nanodiamonds are monodisperse.

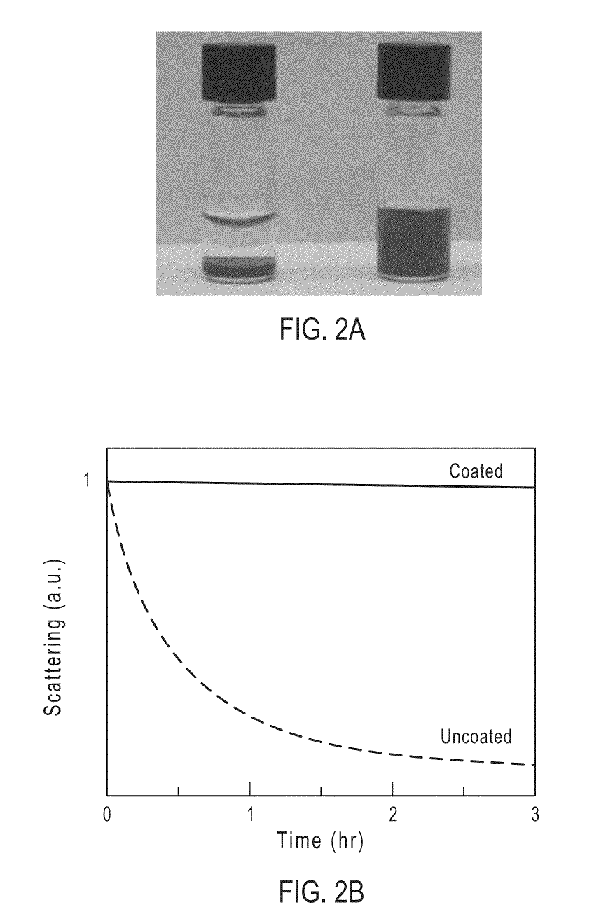

Further, the silica-coated nanodiamonds show colloidal stability. As FIG. 2 illustrates, the uncoated NDs quickly precipitate from solution, whereas the coated have thus far remained in solution for months.

FIG. 2A shows a photograph of two vials containing nanodiamonds in water. The vial on the left contains uncoated ND starting material, while the vial on the right contains silica-coated NDs. FIG. 2B shows a time course for settling of uncoated nanodiamonds (lower line) and silica-coated nanodiamonds (upper line) measured by light scattering. Samples were excited at 635 nm and scattering was measured at 90°. While the silica-coated nanodiamonds remain stably in aqueous solution, the uncoated nanodiamonds quickly precipitate out of aqueous solution during the 3 hr experiment. The scattering of the sample of uncoated nanodiamonds in water was best fit by a double exponential, whereas that of the coated nanodiamonds was best fit by a single exponential.

### Example 2

### Characterization of Silica-Coated Nanodiamonds

The Z-averaged hydrodynamic diameter and zeta potential of both coated and uncoated NDs were analyzed in water as a function of pH using a Malvern Zetasizer Nano Series instrument, which measures particle size using dynamic light scattering and zeta potential using electrophoretic light scattering Adjustments in pH were made using HCl and NaOH. Samples were excited at 635 nm and scattering was measured at 90°.

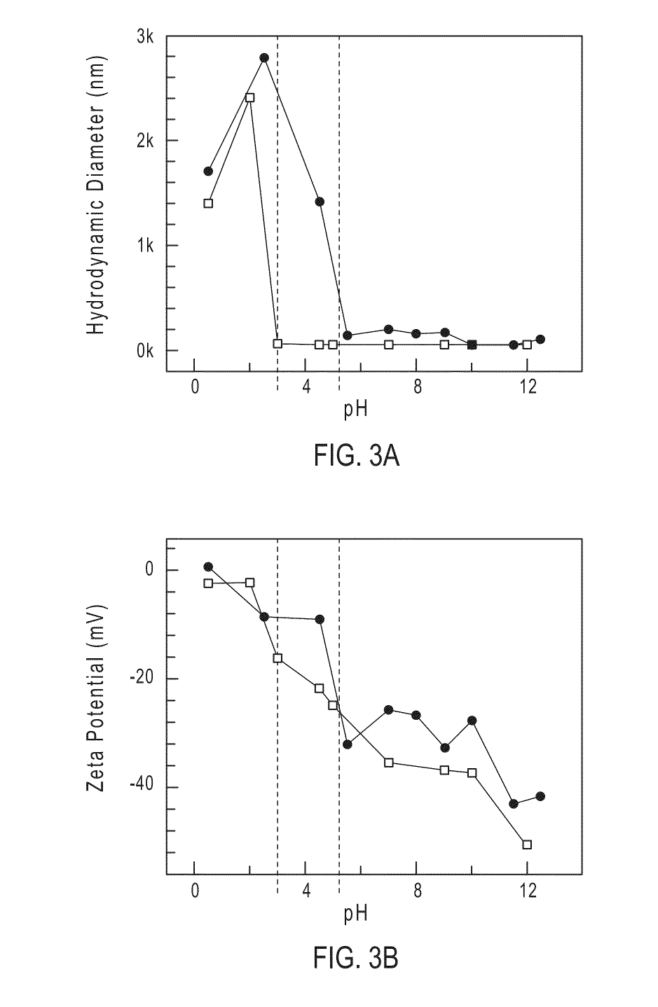

FIGS. 3A and 3B show graphs of the hydrodynamic diameter (FIG. 3A) and zeta potential (FIG. 3B) for NDs, before (circles) and after (squares) silica-coating. The silica-coated NDs were found to be mono-disperse with PDI values below 0.2, particularly above pH 3 where a strong negative zeta potential (−35 mV) allowed the particles to remain in colloidal suspension with a hydrodynamic diameter of −45 nm.

Coating with silica made the NDs anionic, stable and monodisperse across the working pH range, as compared to uncoated ND. The coated ND's negative charge in the physiological pH range of 6-7 is desirable for many biomedical applications because it imitates the negative charge of most biomolecules in this pH range.

FIGS. 3A and 3B also show the hydrodynamic diameter (FIG. 3A) and zeta potential (FIG. 3B) for uncoated NDs. The uncoated NDs tended to have large hydrodynamic diameters while the absolute value of the zeta potential was less than 20 mV. Without being bound by theory, when the surface charge of a particle is low, electrostatic repulsion is no longer strong enough to prevent the particles from aggregating and flocculating, so the recorded hydrodynamic diameter and poly-dispersity index (PDI) readings also increase. In the case of the uncoated NDs, the PDI values for the Z-average hydrodynamic diameters shown were above 0.66, even reaching the maximum of 1, for pH measurements below pH 10, indicating that the diamonds were polydisperse and aggregation was occurring.

### Example 3

### Functionalizing the Silica-Coated Nanodiamonds

Amine-reactive Alexa Flour® 647 (Life Technologies, Inc.) was conjugated to the silica-coated NDs using 3-aminopropyltriethoxysilane (APTES) as an intermediate linker in which the amine group was reacted with the dye and the three ethoxysilane groups reacted with the silanol groups of the silica-coating by the Stöber reaction.

Set forth below are some embodiments of the method for making the silica-coated nanodiamonds disclosed herein and the silica-coated nanodiamonds made thereby.

Accordingly, a method of preparing a silica-coated nanodiamond comprises contacting a nanodiamond entrapped in a liposome with a silica precursor, such as a tetraalkylorthosilicate, specifically tetraethylorthosilicate (TEOS), and reacting the silica precursor to form a silica coating on the nanodiamond; optionally adding a catalyst to the reaction of the silica precursor; optionally purifying the silica-coated nanodiamond; and optionally functionalizing the silica layer of the silica-coated nanodiamond, such as with a labeling material, a therapeutic agent, or a targeting agent; wherein contacting a nanodiamond entrapped in a liposome with a silica precursor comprises contacting a phospholipid film, such as a 1-palmitoyl-2-oleoyl-sn-glycero-3-phosphocholine (POPC) film, with an aqueous solution of the nanodiamond and the silica precursor, such as a tetraalkylorthosilicate, specifically tetraethylorthosilicate (TEOS), to obtain a lipid suspension; and ultrasonicating the lipid suspension to obtain a unilamellar liposome with an entrapped nanodiamond and the silica precursor, wherein the unilamellar liposome optionally has a hydrodynamic diameter in the range of 10 to less than 1 micrometer, or wherein the silica precursor is a tetraalkyl orthosilicate and the method comprises contacting a plurality of nanodiamonds and the tetraalkyl orthosilicate, trapping the nanodiamonds and the tetraalkyl orthosilicate in liposomes, reacting the tetraalkyl orthosilicate to form a silica coating on the nanodiamonds in the liposomes, and purifying the silica-coated nanodiamonds from the liposomes, wherein trapping the nanodiamonds and the tetraalkyl orthosilicate in liposomes comprises contacting a phospholipid film, such as a 1-palmitoyl-2-oleoyl-sn-glycero-3-phosphocholine (POPC) film, with an aqueous solution of the nanodiamonds and the tetraalkyl orthosilicate to obtain a lipid suspension; and ultrasonicating the lipid suspension to obtain a population of unilamellar liposomes, such as unilamellar liposome having a hydrodynamic diameter in the range of 10 to less than 1 micrometer, with entrapped nanodiamonds and tetraalkyl orthosilicate; wherein purifying the silica-coated nanodiamond comprises adding a liposome disrupting compound, such as acetic acid or a surfactant such as sodium dodecyl sulfate (SDS) or Triton X-100, to the liposome suspension; and dialyzing unreacted components and phospholipids away from the silica-coated nanodiamonds.

Optionally, any of the foregoing methods can further comprise adding a catalyst to the reaction of the silica precursor. Any of the foregoing methods, can further optionally comprise purifying the silica-coated nanodiamond. Optionally, any of the foregoing methods can further include a step of functionalizing the silica layer of the silica-coated nanodiamond, such as with a labeling material, a therapeutic agent, or a targeting agent.

A silica-coated nanodiamond comprises a nanodiamond core; and a silica coating disposed at least partially on the diamond core, wherein the silica-coated nanodiamond is substantially free of a surfactant, wherein the silica-coated nanodiamonds have a polydispersity index ≦0.2.

The terms “a” and “an” do not denote a limitation of quantity, but rather denote the presence of at least one of the referenced item. The term “or” means “and/or”. The terms “comprising”, “having”, “including”, and “containing” are to be construed as open-ended terms (i.e., meaning “including, but not limited to”). The modifier “about” used in connection with a quantity is inclusive of the stated value and has the meaning dictated by the context (e.g., includes the degree of error associated with measurement of the particular quantity).

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and are independently combinable.

Unless defined otherwise, technical and scientific terms used herein have the same meaning as is commonly understood by one of skill in the art to which this invention belongs.

All references are incorporated by reference herein.

Embodiments of this invention are described herein, including the best mode known to the inventors for carrying out the invention. Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A silica-coated nanodiamond comprising:
a nanodiamond core; and
a silica layer disposed on or adjacent to the nanodiamond core.

2. The silica-coated nanodiamond of claim 1, wherein the silica layer is disposed at least partially on the nanodiamond core.

3. The silica-coated nanodiamond of claim 1, wherein the silica layer is continuous and fully surrounds the nanodiamond core to provide a core-shell structure.

4. The silica-coated nanodiamond of claim 1, wherein the silica-coated nanodiamond is stable in a room temperature aqueous solution for at least 24 hours.

5. The silica-coated nanodiamond of claim 1, wherein the silica layer is functionalized.

6. The silica-coated nanodiamond of claim 1, wherein the silica layer is functionalized with a labeling material, a therapeutic agent, a targeting agent, or a combination of any of the foregoing.

7. The silica-coated nanodiamond of claim 1, wherein the silica layer is derived from a silica precursor comprising tetraethylorthosilicate.

8. A plurality of silica-coated nanodiamonds, wherein each of the plurality of silica-coated nanodiamonds comprises:
a nanodiamond core; and
a silica layer disposed on or adjacent to the nanodiamond core.

9. The plurality of silica-coated nanodiamonds of claim 8, wherein the plurality of the silica-coated nanodiamonds is characterized by a polydispersity index ≦0.4.

10. A method of preparing a silica-coated nanodiamond, comprising:
contacting a nanodiamond entrapped in a liposome with a silica precursor; and
reacting the silica precursor to form a silica layer on or adjacent to the nanodiamond.

11. The method of claim 10, further comprising functionalizing the silica layer of the silica-coated nanodiamond.

12. The method of claim 10, further comprising functionalizing the silica layer with a labeling material, a therapeutic agent, a targeting agent or a combination thereof to provide a functionalized silica-coated nanodiamond.

13. The method of claim 10, wherein contacting a nanodiamond entrapped in a liposome with a silica precursor comprises:
contacting a phospholipid film with an aqueous solution of the nanodiamond and the silica precursor to obtain a lipid suspension; and
ultrasonicating the lipid suspension to provide a unilamellar liposome with an entrapped nanodiamond and the silica precursor.

14. The method of claim 13, wherein the unilamellar liposome is characterized by a hydrodynamic diameter from 10 nm to 1,000 nm.

15. The method of claim 10, further comprising adding a catalyst to the reaction of the silica precursor.

16. The method of claim 10, further comprising purifying the silica-coated nanodiamond.

17. The method of claim 16, wherein purifying the silica-coated nanodiamonds comprises:
adding a liposome disrupting compound to the suspension; and
dialyzing unreacted components and phospholipids away from the silica-coated nanodiamonds.

18. The method of claim 16, wherein the liposome disrupting compound comprises acetic acid, a surfactant, or a combination thereof.

19. The method of claim 9, wherein the silica precursor comprises a tetraalkyl orthosilicate, and the method comprises:
contacting a plurality of nanodiamonds and the tetraalkyl orthosilicate;
trapping the plurality of nanodiamonds and the tetraalkyl orthosilicate in liposomes;
reacting the tetraalkyl orthosilicate to form a silica layer on or adjacent to the plurality of nanodiamonds within the liposomes to form a suspension comprising silica-coated nanodiamonds; and
purifying the silica-coated nanodiamonds.

20. A silica-coated nanodiamond made by the method of claim 10.
